(19) United States
(12) Patent Application Publication
(10) Pub. No.: US 2023/0332444 A1
(43) Pub. Date: Oct. 19, 2023

(54) VEHICLE DOOR HANDLE ASSEMBLY

(71) Applicant: U-shin Italia S.p.A, Pianezza (IT)

(72) Inventors: Guillaume DESPREAUX, Pianezza (IT); Anthony GUERIN, Pianezza (IT)

(73) Assignee: U-shin Italia S.p.A, Pianezza (IT)

(21) Appl. No.: 18/299,914

(22) Filed: Apr. 13, 2023

(30) Foreign Application Priority Data
Apr. 13, 2022 (EP) 22168081.2

(51) Int. Cl. E05B 85/10

(52) U.S. Cl. CPC E05B 85/107; E05B 85/103

(57) ABSTRACT

A vehicle door handle assembly includes: a bracket and a movable handle configured for moving between a retracted position, in which the handle flushes with an outer side of a door panel skin, and a deployed position. The bracket is arranged directly on an inner side of a door panel skin, and the handle is arranged on the outer side of the door panel skin and is fastened to the bracket.

### TECHNICAL FIELD

The present invention relates to the field of vehicle door handles to control the opening of vehicle doors and in particular to retractable vehicle door handles configured for moving from a retractable position wherein the handle flushes with the outer side of the door panel to reduce drag when the vehicle is moving and a deployed position wherein the handle can be grabbed by a user to open the door.

### BACKGROUND OF THE INVENTION

On one side, the thickness of the grabbable part of a retractable vehicle door handles needs to be as reduced as possible in order to provide enough space in order for the user to introduce his fingers in the free space defined by the handle to pull the handle in order to activate a latch and open the door while limiting the space required for the handle when in the retracted position due to the limited space available in the door body. The deployed dimension of the handle represented by the height H in FIG. 1 is also limited to 40mm by the regulations.

On the other side, the handle has to be strong enough to withstand the strain applied by the user when pulling on the handle.

Furthermore, the handle has to comprise a limited number of parts in order to limit the cost of the parts and to ease the assembly of the handle.

Moreover, the handle protruding from the car panel in the deployed position has to look perfect as it is seen by the user each time he opens the door. Thus, the manufacturing techniques used for the handle have to prevent the appearance of visible defects.

### SUMMARY OF THE INVENTION

It is therefore a goal of the present invention to provide a solution to provide a door handle assembly with a movable handle having a limited number of parts that is easy to be assembled to reduce the overall cost by limiting the number of parts and the number of steps required for the assembly. The door handle has also to be stiff enough to withstand the constraints applied by the user.

Thus, the present invention refers to a vehicle door handle assembly comprising:
a bracket and,
a movable handle configured to be fastened to the bracket and configured for moving between a retracted position wherein the handle flushes with an outer side of a door panel skin and a deployed position,
   wherein the handle comprises a casing made of a first part comprising a recess extending along the length of the casing and configured for receiving an electronic unit and a second part configured to be fastened to the first part and covering the recess of the first part, the handle also comprising an elongated metallic plate configured to be positioned in the recess to increase the stiffness of the handle.

The use of a casing comprising a recess configured for receiving a reinforcement plate allows obtaining a handle having a reduced thickness and a stiffness and robustness high enough to withstand the constraints applied by the users. Such reduced thickness also provides an enlarged space for the users' fingers.

According to another aspect of the present invention, the elongated metallic plate is fastened on the first part of the casing by screws.

According to another aspect of the present invention, the elongated metallic plate is superimposed to the electronic unit in the recess.

According to another aspect of the present invention, the bracket is configured to be fixed to an inner side of a door panel skin and comprises a first and a second levers configured for protruding through at least one opening of the door panel skin towards the outer side of the door panel skin and the handle comprises a first and a second sleeves configured to be fastened respectively to the first and the second levers.

According to another aspect of the present invention, the first part of the casing is made of plastics.

According to another aspect of the present invention, the second part of the casing is a chrome cover.

According to another aspect of the present invention, the second part of the casing is fastened to the first part by screws.

According to another aspect of the present invention, the electronic unit comprises a printed circuit board and a conductive wire configured to be linked on one side to the ground of the printed circuit board and on the other side to the elongated metal plate and/or to the second part of the cover.

According to another aspect of the present invention, the electronic unit comprises a connector configured to be connected to a complementary connector of the bracket when the handle is fastened to the bracket to ensure the power supply of the electronic unit.

### BRIEF DESCRIPTION OF THE DRAWINGS

Other advantages and characteristics will appear with the reading of the description of the following drawings:

FIG. 1 is a top view of a of a movable door handle in a deployed position;

FIG. 2 is a perspective view of a vehicle door handle assembly according to an embodiment of the present invention;

FIG. 3 is a perspective view of a casing of a vehicle door handle assembly according to an embodiment of the present invention;

FIG. 4 is a perspective view of an electronic unit and a first part of a casing of a vehicle door handle assembly according to an embodiment of the present invention;

FIG. 5 is a perspective view of an electronic unit located in a recess of a casing of a vehicle door handle assembly according to an embodiment of the present invention;

FIG. 6 is a perspective view of a metallic plate and a first part of a casing of a vehicle door handle according to an embodiment of the present invention;

FIG. 7 is a perspective view of a vehicle door handle according to an embodiment of the present invention in the assembled state;

FIG. 8 is a perspective view of a wire of the vehicle door handle coupled to the ground of the electronic unit;

FIG. 9 is a perspective view of parts of a vehicle door handle assembly arranged on a door panel skin;

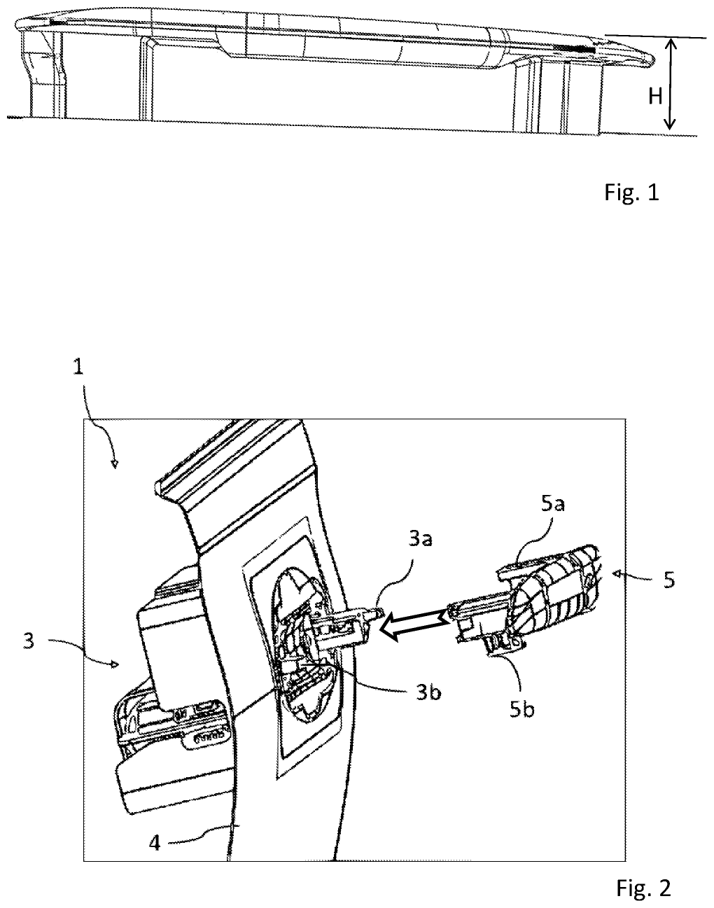

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments.

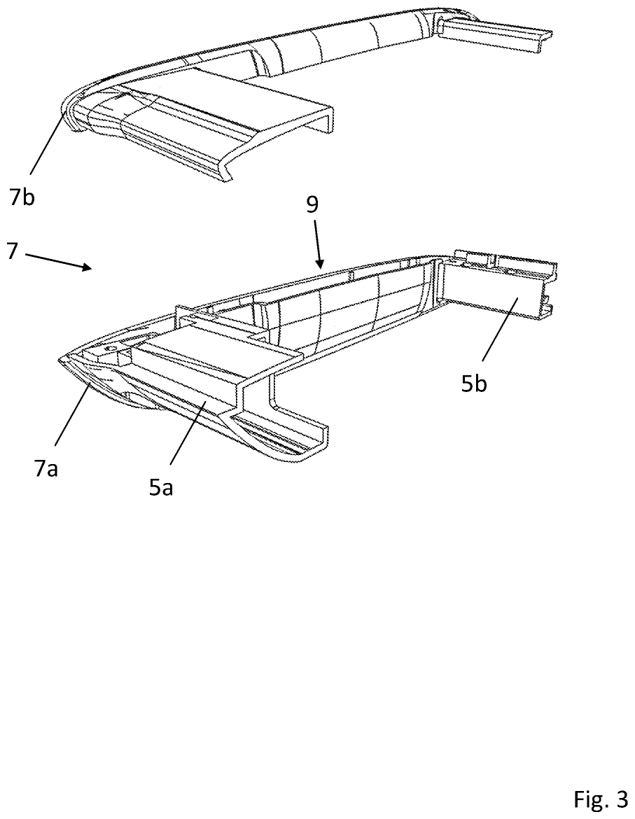

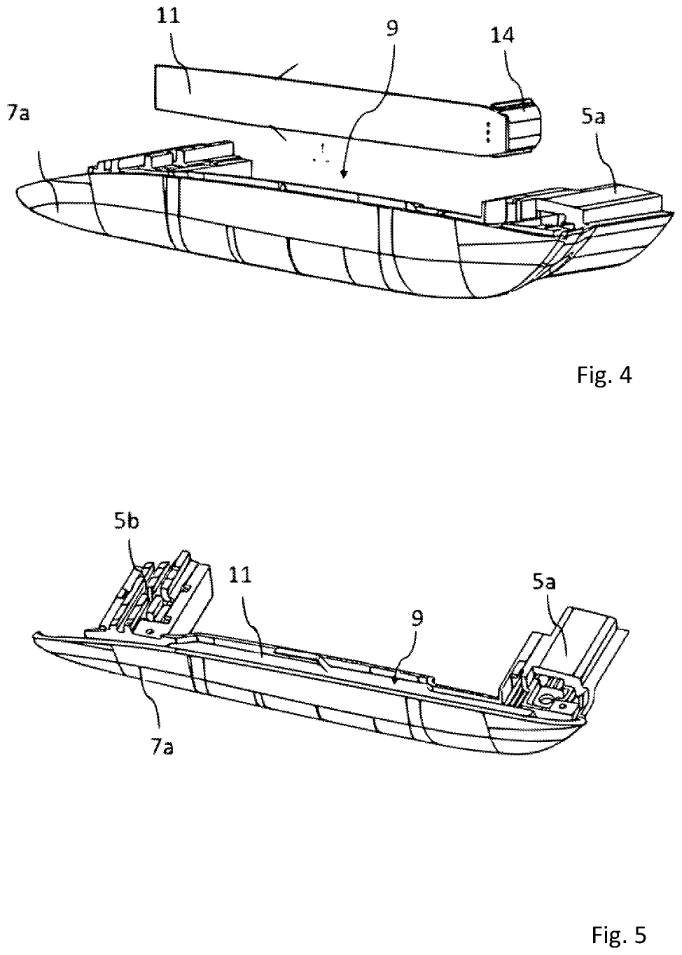

The present invention refers to a vehicle door handle assembly 1. FIG. 2 represents an exploded view of such assembly 1. The vehicle door handle assembly 1 comprises a bracket 3 configured to be fixed to a door panel skin 4 and a movable handle 5 configured to be fastened to the bracket 3. The movable handle 5 is configured for moving between a retracted position wherein the handle 5 flushes with an outer side of the door panel skin 4 and a deployed position wherein the user can grab and pull the handle 5. The bracket 3 is configured to be fixed to the inner side of the door panel skin 4, for example by screws. The door panel skin 4 comprises one or several openings located in front of the bracket 3 to allow a first and a second levers 3a and 3b of the bracket 3 to protrude through the door panel skin 4. The movable handle 5 is configured to be fastened to the first and the second levers 3a and 3b of the bracket 3, for example by clips or any suitable fastening means. As represented in FIG. 3, the movable handle 5 comprises a casing 7 made of a first part 7a and a second part 7b. The first part 7a is configured to be the bottom part and the second part 7b is configured to be the top part when assembled to the vehicle, the second part 7b being configured to cover the first part 7a. The first part 7a may be made of plastics and the second part 7b may be made of plastics and covered by chrome. The casing 7 has a general U-shape with a longitudinal straight part destined to be grabbed by the user and a first and a second arms 5a and 5b extending orthogonally from the longitudinal straight part and configured to be fastened to the levers 3a, 3b of the bracket 3. The first part 7a comprises a recess 9 extending along the length of the casing 7. The recess 9 is configured for receiving an electronic unit 11 as represented in FIGS. 4 and 5. The electronic unit 11 may be made of a printed circuit board (PCB) and may comprise an antenna configured for receiving a signal from a user's key in order to unlock the latch associated with the vehicle door handle assembly and/or configured for detecting a user's hand grabbing the handle. The electronic unit 11 may also comprise a switch configured to be linked to a command button 19 of the movable handle 5 as represented in FIG. 9. Such button 19 may be used by the user to deploy the movable handle 5. The electronic unit 11 also comprises a connector 14 configured to be connected to a complementary connector of the bracket 3 when the handle 5 is fastened to the bracket 3 to ensure the power supply of the electronic unit 11.

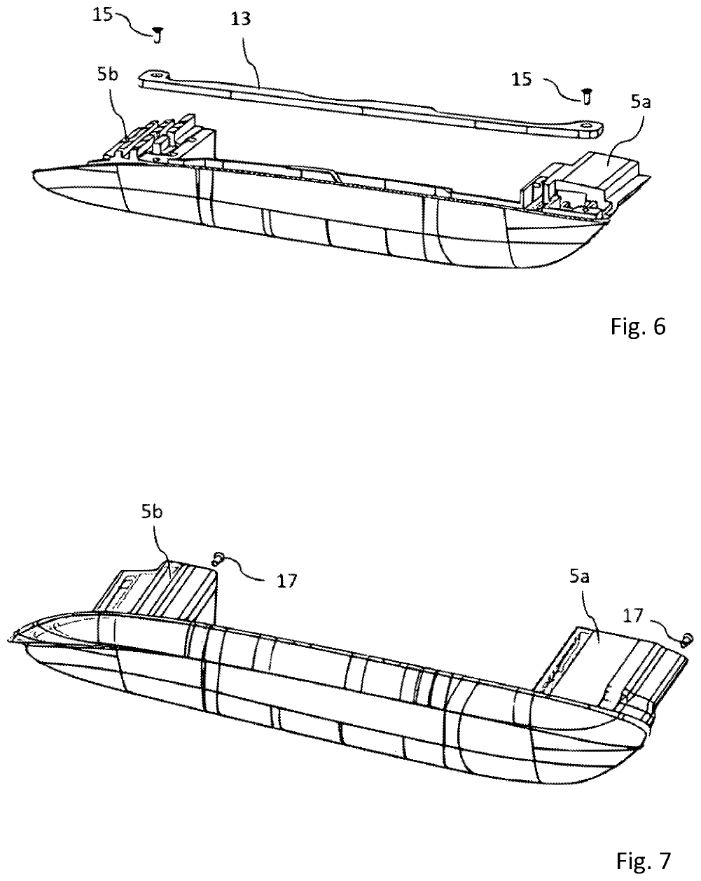

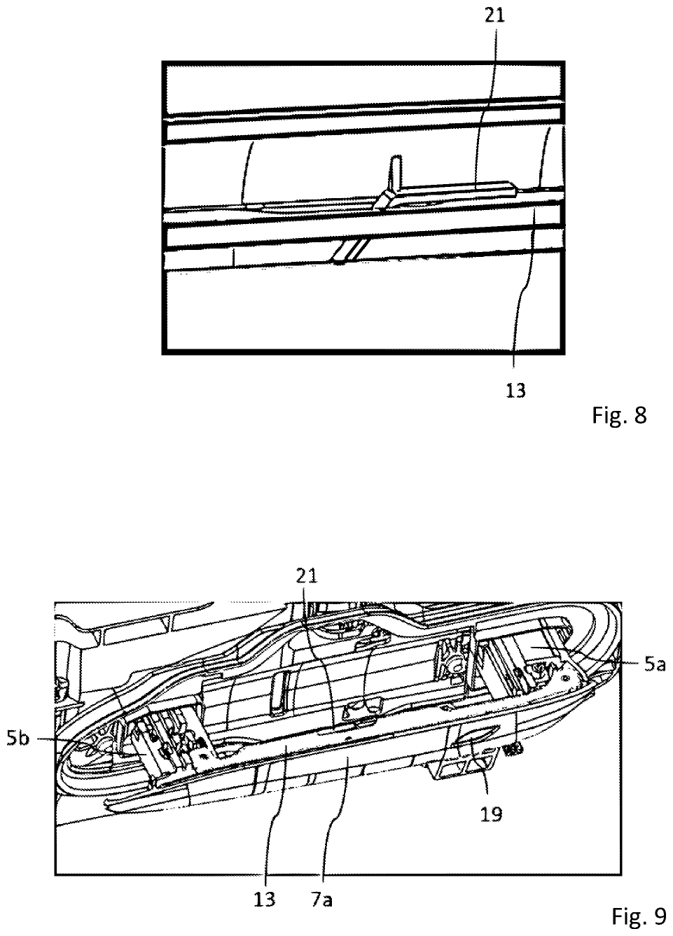

The recess 9 is straight or slightly curved if the shape of the handle 5 does not allow a straight shape. As represented in FIG. 6, the movable handle 5 also comprises an elongated metallic plate 13 configured to be positioned in the recess 9 and along the recess 9, for example on top of the electronic unit 11 to increase the stiffness of the movable handle 5. The elongated metallic plate 13 may also be positioned outside of the recess 9 or in a recess different from the recess 9 configured for receiving the electronic unit 11. The elongated metallic plate 13 may be made of steel or aluminium. The elongated metallic plate 13 may be fixed to the first part 7a of the casing 7 by two screws 15. The second part 7b of the casing corresponds to a cover of the first part 7a, for example a chrome cover configured for recovering the recess 9. The second part 7b may also have a general U-shape with a longitudinal portion and a first and a second arms. The second part 7b may be fastened to the first part 7a by screws 17 as represented in FIG. 7.
Furthermore, as represented in FIGS. 8 and 9, the electronic unit 11 may comprise a conductive wire 21 configured to be linked on one side to the ground of the printed circuit board and on the other side to the elongated metal plate 13 and/or to the chromed portion of the second part 7b of the casing 7.

The use of a casing 7 with a first part 7a comprising a recess 9 to receive the electronic unit 11 and the metallic plate 13 and a second part 7b corresponding to a chrome cover enables obtaining a handle 5 having a smooth design without defects as there is no overmolding process.

In order to allow the deployment of the handle 5, the bracket 3 may comprise a deformable parallelogram mechanism configured for moving between a retracted and a deployed position. Two opposite branches of the parallelogram correspond to the first 3a and the second 3b levers configured for protruding through the openings of the door panel skin 4 in the deployed position of the deformable parallelogram mechanism as represented in FIG. 2.

When the deformable parallelogram mechanism 13 is in the deployed position, the first 3a and the second 3b levers protrude on the outer side of the door panel skin 4 so that the handle 5 can be fastened to the said first 3a and second 3b levers as represented in FIG. 9.

The handle 5 comprises a first sleeve 5a corresponding to the first arm 5a and configured for coming around the first lever 3a and a second sleeve 5b corresponding to the second arm 5b and configured for coming around the second lever 3b.

The handle 5 may be clipped to the first 3a and second 3b levers. When the handle 5 is positioned onto the first and second levers 3a, 3b, the connector 14 of the first sleeve 5a is plugged to the complementary connector of the bracket 3 located in the first lever 3a to ensure the power supply of the electronic unit 11.

The bracket 3 may also comprise an electrical actuator (not represented) such as an electrical motor linked to the deformable parallelogram mechanism in order to displace the handle 5 between the retracted position and the deployed position (the deployed and retracted position of the handle 5 correspond to the deployed and retracted position of the deformable parallelogram mechanism). The handle 5 comprises for example a command button 19 on its outer side and a push on the said command button 19 by a user leads to the transmission of a command signal towards the electrical actuator to deploy or retract the handle 5.

Thus, the elongated metallic plate 13 provides stiffness to the handle 5 to avoid bending or even breaking of the handle 5 under the action of the user, when the user pulls the handle 5. Furthermore, the use of a two-part casing 7 with a recess for receiving the elongated metallic plate 13 enables limiting the number of pieces of the vehicle door handle assembly 1 while ensuring a smooth appearance without defects due for example to an overmolding of the casing around the elongated metallic plate 13.

1. A vehicle door handle assembly comprising:
a bracket; and
a movable handle configured to be fastened to the bracket and configured for moving between a retracted position wherein the movable handle flushes with an outer side of a door panel skin and a deployed position,
wherein the movable handle comprises a casing made of a first part comprising a recess extending along the length of the casing and configured for receiving an electronic unit and a second part configured to be fastened to the first part and covering the recess of the first part, the handle also comprising an elongated metallic plate to increase the stiffness of the movable handle.

2. The vehicle door handle assembly in accordance with claim 1, wherein the elongated metallic plate is configured to be positioned in the recess.

3. The vehicle door handle assembly in accordance with claim 2, wherein the elongated metallic plate is superimposed to the electronic unit in the recess.

4. The vehicle door handle assembly in accordance with claim 1, wherein the elongated metallic plate is fastened to the first part of the casing by screws.

5. The vehicle door handle assembly in accordance with claim 1, wherein the bracket is configured to be fixed to an inner side of a door panel skin and comprises a first and a second levers configured for protruding through at least one opening of the door panel skin towards the outer side of the door panel skin and wherein the handle comprises a first and a second arms configured to be fastened respectively to the first and the second levers of the bracket.

6. The vehicle door handle assembly in accordance with claim 1, wherein the first part of the casing is made of plastics.

7. The vehicle door handle assembly in accordance with claim 1, wherein the second part of the casing is a chrome cover.

8. The vehicle door handle assembly in accordance with claim 1, wherein the second part of the casing is fastened to the first part by screws.

9. The vehicle door handle assembly in accordance with claim 1, wherein the electronic unit comprises a printed circuit board and a conductive wire configured to be linked on one side to the ground of the printed circuit board and on the other side to the elongated metal plate and/or to the second part of the casing.

10. The vehicle door handle assembly in accordance with claim 1, wherein the electronic unit comprises a connector configured to be connected to a complementary connector of the bracket when the handle is fastened to the bracket to ensure the power supply of the electronic unit.
